(19) United States
(12) Patent Application Publication
(10) Pub. No.: US 2026/0093557 A1
(43) Pub. Date: Apr. 2, 2026

(54) AUTOMATIC DEFINITION OF BACK OFFICE JOBS BASED ON DEVICE MOBILE ORIGINATED PUSH SCHEDULES

(71) Applicant: Itron, Inc., Liberty Lake, WA (US)

(72) Inventors: David Kong, San Mateo, CA (US); Valeriya Pasynkova, San Francisco, CA (US); Conroy Tam, San Jose, CA (US)

(21) Appl. No.: 19/264,708

(22) Filed: Jul. 9, 2025

Related U.S. Application Data
(60) Provisional application No. 63/701,450, filed on Sep. 30, 2024.

(51) Int. Cl. G06F 9/50; G06F 9/48

(52) U.S. Cl. CPC G06F 9/5094; G06F 9/4893

(57) ABSTRACT

Techniques for obtaining a Mobile Originating (MO) push schedule from a device in a wireless network are described herein. For example, the system may request MO push schedules from device endpoints and compare the MO push schedule with existing job schedules stored by the system. If no existing job schedule matches the MO push schedule, the system may generate a new job schedule and add the endpoint as a member of the job schedule. In some cases, if an existing job schedule matches the MO push scheduled, the system may add the endpoint as a member of the existing job schedule. In some examples, the system may receive an indication that the MO push schedule of the endpoint has changed and may add and/or remove the endpoint from a job schedule based on an updated MO schedule received from the device endpoint.

### BACKGROUND

This application claims priority to U.S. Provisional Application No. 63/701,450, titled “Automatic Definition of Back Office Jobs Based on Device Mobile Originated Push Schedules,” filed Sep. 30, 2024, which is hereby incorporated by reference in its entirety.

### BACKGROUND

Battery operated devices may be remotely deployed and communicate with utility services via cellular-based communications. These devices may not be serviced for multiple years, and it may be desirable to extend the battery life of the devices by minimizing communication between the device and the utility service. Mains power devices may also be configured to communicate with utility services and the utility services may desire to allocate adequate resources for receiving and processing data from both battery operated and mains power devices. It is important for the utility service to know when data will be received and what types of data will be received in order for device performance tracking as well as resource management

### BRIEF DESCRIPTION OF DRAWINGS

FIG. 1 is a schematic diagram of an example network architecture.

FIG. 2 is a diagram showing details of an example device.

FIG. 3 is a diagram showing details of another example device.

FIG. 4 illustrates an example process for obtaining a Mobile Originating (MO) push schedule.

FIG. 5 illustrates another example process for obtaining an MO push schedule.

FIG. 6 illustrates another example process for providing an MO push schedule.

### DETAILED DESCRIPTION

Systems and methods are discussed herein including obtaining MO push schedules for remotely deployed devices. For example, a utility service may desire to obtain MO push schedules from remotely deployed devices (e.g., smart utility meters) and generate job schedules to track which devices are scheduled to be included in each job. A job schedule may include a period of time in which the utility service (e.g., also referred to as the system) may receive communications (e.g., utility data) from devices and perform one or more operations, such as data processing. It may be desirable to obtain the MO push schedules from the devices in order to know which devices to expect to be receiving communications from and when to expect to receive the communications. For example, it may be desirable for device performance tracking to track devices for which the system has successfully received and processed data, and the devices for which it has not. Device performance tracking is an indicator that utility services use to understand their ability to generate bills. It is common for utility services to include job performance in service level agreements (SLA) with a network provider utilized by the devices and/or utility service. Another reason the utility service may desire to obtain MO push schedules for devices is that the utility service may use a central processing unit (CPU) and memory to process data received by the devices (e.g., endpoints). Job schedules and tracking of job status may be used by the system to manage CPU and/or memory utilization so that expected data from devices can be processed without the utility service running out of or exhausting computing resources. Historically, relying on users to define job schedules for MO push schedules has been problematic as user-entered data may be inaccurate and/or untimely.

In some cases, the system may request MO push schedules from each remote device endpoint and compare the MO push schedule with existing job schedules stored by the system. If no existing job schedule matches the MO push schedule, the system may generate a new job schedule and add the endpoint as a member of the job schedule. In some cases, if an existing job schedule matches the MO push schedule, the system may add the endpoint as a member of the job schedule. In some examples, the system may receive an indication that the MO push schedule of the endpoint has changed and may add and/or remove the endpoint from a job schedule based on an updated MO schedule received from the endpoint.

In some examples, the techniques are implemented in the context of or in compliance with a standard, such as the Wireless Smart Utility Network (Wi-SUN) standard (e.g., Wi-SUN Field Area Network (Wi-SUN FAN)), IEEE 802.15.4-2015 (e.g., wireless mesh network), etc. Further, the techniques may be implemented in the context of the Internet of Things (IoT). As such, a wide variety of devices may be used to implement some or all of the techniques described herein.

By way of example and not limitation, network communication devices (sometimes referred to as nodes, computing devices, endpoint, or just devices) include utility meters (e.g., electricity, water, or gas meters), relays, repeaters, routers, transformers, sensors, switches, encoder/receiver/transmitters (ERTs), appliances, personal computers (e.g., desktop computers, laptop computers, etc.), mobile devices (e.g., smartphones, tablets, personal digital assistants (PDAs), electronic reader devices, etc.), wearable computers (e.g., smart watches, optical head-mounted displays (OHMDs), etc.), servers, access points, portable navigation devices, portable gaming devices, portable media players, televisions, set-top boxes, computer systems in an automobile (e.g., navigation systems), cameras, robots, hologram systems, security systems, home-based computer systems (e.g., intercom systems, home media systems, etc.), projectors, automated teller machines (ATMs), and so on. In some instances, a network communication device may comprise a battery powered network communication device (also referred to as a “battery powered device”) that relies on a battery for power (i.e., is not connected to mains power). In other instances, a network communication device (also referred to as a “mains powered device”) may comprise a mains powered device that relies on mains power for electricity.

### Example Environment

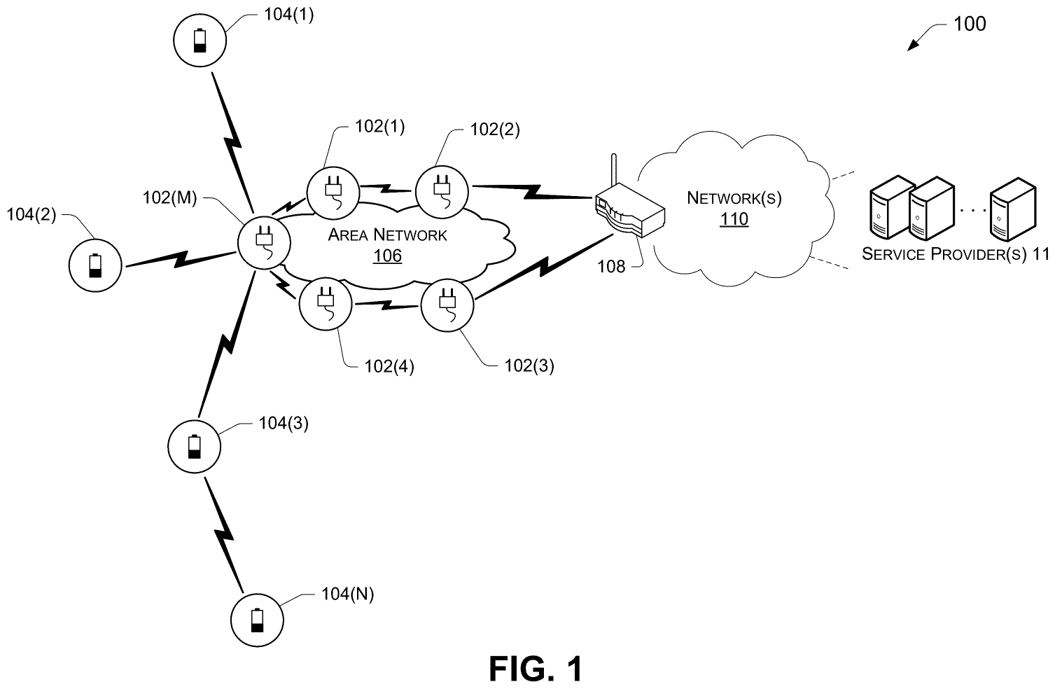

FIG. 1 is a diagram illustrating an example networked environment or architecture 100. The architecture 100 includes multiple network communication devices. The network communication devices include devices 102(1), 102(2), 102(3), 102(4), . . . 102(M) (collectively referred to as “devices 102”), and devices 104(1), 104(2), 104(3), . . . 104(N) (collectively referred to as “devices 104”), where M and N are any integers greater than or equal to 1 and may be the same number or different numbers. In some illustrations, the devices 102 include more functionality/resources than the devices 104. In one example, the devices 102 are implemented as mains powered devices (MPDs) that are connected to mains electricity (e.g., electricity meters), while the devices 104 are implemented as battery powered devices (BPDs) that are not connected to mains electricity (e.g., water meters, gas meters, etc. that employ batteries). However, in other examples, the devices 102 and devices 104 may have different processing power, processing capabilities, and so on. The techniques discussed herein may be implemented to communicate between devices 102, devices 104, or any combination of devices.

The network communication devices are in communication with one another via an area network (AN) 106. As used herein, the term “area network” refers to a defined group of devices that are in communication with one another via one or more wired or wireless links. Examples of area networks include, for example, local area networks (LANs), neighborhood area networks (NANs), personal area networks (PANs), home area networks (HANs), Field Area Networks (FANs), cellular networks (e.g., 2G, 3G, 4G, 5G, etc.) or the like. While only one AN 106 is shown in FIG. 1, in practice, multiple ANs may exist and may collectively define a larger network, such as an advanced metering infrastructure (AMI) of a utility communication network. At any given time, each individual device may be a member of a particular AN. Over time, however, devices may migrate from one AN to another geographically proximate or overlapping AN based on a variety of factors, such as respective loads on the ANs, battery reserves, interference, or the like.

The term “link” refers to a direct communication path between two devices (without passing through or being relayed by another device). A link may be over a wired or wireless communication path. Each link may represent a plurality of channels over which a device is able to transmit or receive data. Each of the plurality of channels may be defined by a frequency range which is the same or different for each of the plurality of channels. In some instances, the plurality of channels comprises radio frequency (RF) channels. The AN 106 may implement a channel hopping sequence, such that a channel may change over time. Although many examples discussed herein implement a plurality of channels as data channels, in some instances the plurality of channels include a control channel that is designated for communicating messages to specify a data channel to be utilized to transfer data. Transmissions on the control channel may be shorter relative to transmissions on the data channels.

The AN 106 may comprise a mesh network, in which the network communication devices relay data through the AN 106. Alternatively, or additionally, the area network 106 may comprise a star network, in which a central device acts as parent to one or more child devices. For example, the device 102(M) may act as a parent to the devices 104(1), 104(2), and 104(3). Further, in some instances the AN 106 may include a portion that is implemented as a mesh network and a portion that is implemented as a star network. Moreover, in other instances the AN 106 may be implemented in whole or part by other types of networks, such as hub-and-spoke networks, mobile networks, cellular networks, etc. In some instances, a device may be able to communicate with multiple different types of networks (e.g., a mesh network and a star network) at the same or different times. For instance, if a device is unable to discover a suitable device in a mesh network mode, the device may attempt to connect to a nearby star network, mobile data collection network, or cellular network. Regardless of the topology of the AN 106, individual network communication devices may communicate by wireless (e.g., radio frequency) and/or wired (e.g., power line communication, Ethernet, serial, etc.) connections.

The network communication devices also include an edge device 108, which serves as a connection point of the AN 106 to one or more networks 110 (e.g., a backhaul network), such as the Internet. The edge device 108 may include, but is not limited to, a field area router (FAR), a cellular relay, a cellular router, an edge router, a DODAG (Destination Oriented Directed Acyclic Graph) root, a root device or node of the AN, a combination of the foregoing, or the like. In this illustrated example, the edge device 108 comprises a FAR, which relays communions from the AN 106 to one or more service providers 112 via the network(s) 110.

In some instances, the one or more service providers 112 comprise one or more central office systems that include a security service such as Authentication, Authorization and Accounting (AAA) server, a network registration service such as Dynamic Host Configuration Protocol (DHCP) server, a network management service (NMS), a collection engine (CE), a meter data management system (in the utility context), a customer relationship management system (in the sales context), a diagnostic system (in a manufacturing context), an inventory system (in a warehouse context), a patient record system (in the healthcare context), a billing system, etc. The network communication devices may register or interact with some or all of these one or more central office systems. In one example, the one or more central office systems may implement a meter data management system to collect resource consumption data from the network communication devices of the AN 106, process the resource consumption data, provide data regarding resource consumption to customers, utilities, and others, and/or perform a variety of other functionality. In other instances, the one or more service providers 112 comprise other systems to implement other functionality, such as web services, cloud services, and so on. In yet other instances, the one or more service providers 112 may be implemented as other types of devices, such as in the context of the Internet of Things (IoT) that allows a variety of devices to exchange data.

The one or more service providers 112 may be physically located in a single central location, or may be distributed at multiple different locations. The one or more service providers 112 may be hosted privately by an entity administering all or part of the communications network (e.g., a utility company, a governmental body, distributor, a retailer, manufacturer, etc.), or may be hosted in a cloud environment, or a combination of privately hosted and cloud hosted services.

In some examples, the service providers 112 may receive identifying information for the devices 102 and/or the devices 104 (e.g., a medium access control (MAC) address) and may send a request to the devices 102 and/or the devices 104 (also referred to as “endpoint devices”) for a MO push schedule. In some examples, the service providers 112 may receive the MO push schedule from the devices 102 and/or the devices 104 and determine if the MO push schedule corresponds to a job schedule. For example, the service providers 112 may store multiple job schedules associated with communicating with utility devices, such as devices 102 and/or the devices 104. A job schedule may include a period of time in which the service providers 112 may expect to receive communications (e.g., utility data) from devices 102 and/or the devices 104 and perform one or more operations, such as data processing. In some cases, the service providers 112 may determine that the received MO push schedule corresponds to a previous job schedule and may add the devices 102 and/or the devices 104 to the job schedule for further communication. In other cases, the service providers may determine that the MO push schedule does not correspond to an existing job schedule and may generate a new job schedule and add the devices 102 and/or the devices 104 to the new job schedule.

### Example Network Communications Devices

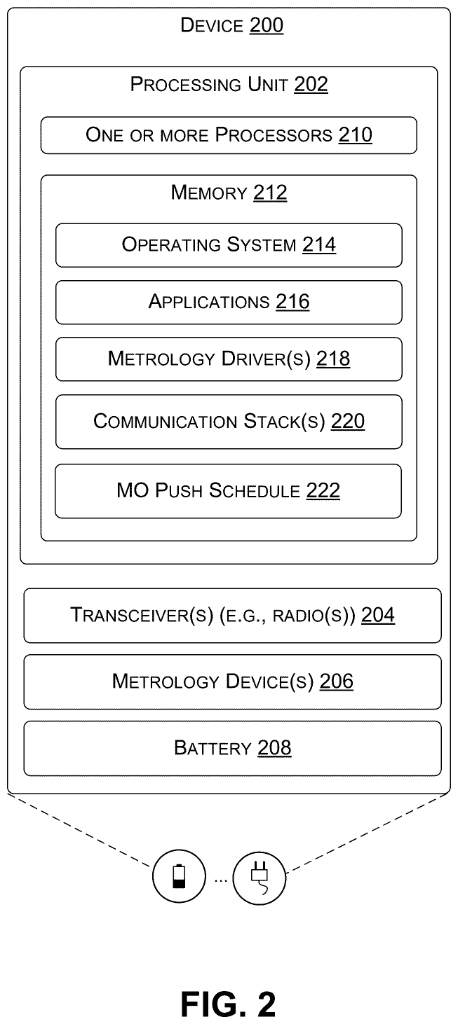

FIG. 2 is a diagram showing details of an example device 200 (sometimes referred to as a Mains Powered Device (MPD) or a battery-operated device). In some cases, device 200 may be the same or similar to the devices 102 and/or the devices 104. In this example, device 200 comprises a device that may be connected to mains power and/or include a battery, such as an electricity meter, sensor, etc. However, as discussed above, devices can take numerous different forms, depending on the industry and context in which they are deployed. Different types of devices may have different physical and/or logical components. For instance, utility meter devices such as that shown in FIG. 2 may have metrology components, whereas other types of devices may not.

As shown in FIG. 2, the example device 200 includes a processing unit 202, a transceiver 204 (e.g., radio), one or more metrology devices 206, and a battery 208. The processing unit 202 may include one or more processors 210 and memory 212. When present, the one or more processors 210 may comprise microprocessors, central processing units, graphics processing units, or other processors usable to execute program instructions to implement the functionality described herein. Additionally, or alternatively, in some examples, some or all of the functions described may be performed in hardware, such as an application specific integrated circuit (ASIC), a gate array, or other hardware-based logic device.

Transceiver 204 may comprise one or more hardware and/or software implemented radios to provide two-way RF communication with other network communication devices in the AN 106 and/or other computing devices via the network 110. Transceiver 204 may additionally or alternatively include a modem to provide power line communication (PLC) communication with other network communication devices that are connected to an electrical service grid.

Metrology device(s) 206 comprise the physical hardware and sensors to measure consumption data of a resource (e.g., electricity, water, or gas) at a site of the meter. In the case of an electric meter, for example, the metrology device(s) 206 may include one or more Hall effect sensors, shunts, or the like. In the case of water and gas meters, the metrology device(s) 206 may comprise various flow meters, pressure sensors, or the like. Metrology device(s) 206 may report the consumption data to one or more service providers 112 via the transceiver 204. The consumption data may be formatted and/or packetized in a manner or protocol for transmission.

Memory 212 includes an operating system (OS) 214 and one or more applications 216 that are executable by one or more processors 210. The memory 212 may also include one or more metrology drivers 218 configured to receive, interpret, and/or otherwise process the metrology data collected by the metrology device(s) 206. Additionally, or alternatively, one or more of the applications 216 may be configured to receive and/or act on data collected by the metrology device(s) 206.

Memory 212 may also include one or more communication stacks 220. In some examples, the communication stack(s) 220 may be configured to implement various standard network communication protocols such as 6LowPAN protocol, an 802.15.4c (TDMA CSM/CA) protocol, an 802.15.4-2015 protocol, and/or another protocol.

However, in other examples, other protocols may be used, depending on the networks with which the device is intended to be compatible. The communication stack(s) 220 describe the functionality and rules governing how the device 200 interacts with each of the specified types of networks. For instance, the communication stack(s) 220 may cause battery powered devices to operate in ways that minimize the battery consumption when they are connected to these types of networks.

In some instances, the device 200 may be configured to send or receive communications on multiple channels simultaneously. For example, transceiver(s) 204 may be configured to receive data at the same time on hundreds of channels. Additionally, or alternatively, transceiver(s) 204 may be configured to send data at the same time on hundreds of channels.

The memory 212 may also include an MO push schedule 222 configured to store communication time periods in which the device 200 is configured to generate and send communications. In some cases, device 200 may be configured to provide the MO push schedule 222 to other devices. For instance, device 200 may receive a request from a service provider, such as the service provider 112, to provide the service provider with the MO push schedule 222. In response, the device 200 may send a communication to the service provider including the MO push schedule 222. In this way, the service provider may add the device 200 as a member of a job schedule based on the MO push schedule 222.

The specific characteristics of the battery 208 may vary widely depending on the type of device. By way of example and not limitation, the battery 208 may comprise a Lithium Thionyl Chloride battery, a Lithium Manganese Dioxide battery, a Lithium-Ion battery, a Lithium intercalated compound battery, a lead-acid battery, an alkaline battery, and so on. In some cases, the battery 208 may include a 3.2 to 3.6 volt range per cell. In some cases, the battery 208 may be organized in single, serries, or parallel configurations in a given device.

The various memories described herein are examples of computer-readable media. Computer-readable media may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device. As defined herein, computer-readable media does not include transitory media, such as modulated data signals and carrier waves, and/or signals.

While detailed examples of certain devices are described herein, it should be understood that those computing devices may include other components and/or be arranged differently. As noted above, in some instances a computing device may include one or more processors and memory storing processor executable instructions to implement the functionalities they are described as performing. Certain computing devices may additionally or alternatively include one or more hardware components (e.g., application specific integrated circuits, field programmable gate arrays, systems on a chip, and the like) to implement some or all of the functionalities they are described as performing.

By way of example and not limitation, the device 200 may implement a variety of modulation techniques and/or data rates, such as frequency-shift keying (FSK) 802.15.4g (e.g., mandatory mode with a data rate of 50 kbps or 75 kbps, no forward error correction; legacy mode with a data rate of 150 kbps with forward error correction code rate ½; option 2; etc.), offset quadrature phase-shift keying (OQPSK) modulation with direct-sequence spread spectrum (DSSS) spreading, and so on. To implement these different connection modes, a media access control (MAC) sub-layer of a device may be able to indicate to a physical layer the modulation technique and data rate to be used for each transmission.

In many instances, information that is included in an information element may be stored in memory 212 of the device 200. For example, memory 212 may store any information regarding an operating context, such as schedule data, channel data, seed data, timing data, and so on. In some instances, components of device 200 may reference the information to determine how to communicate according to a specific operating context.

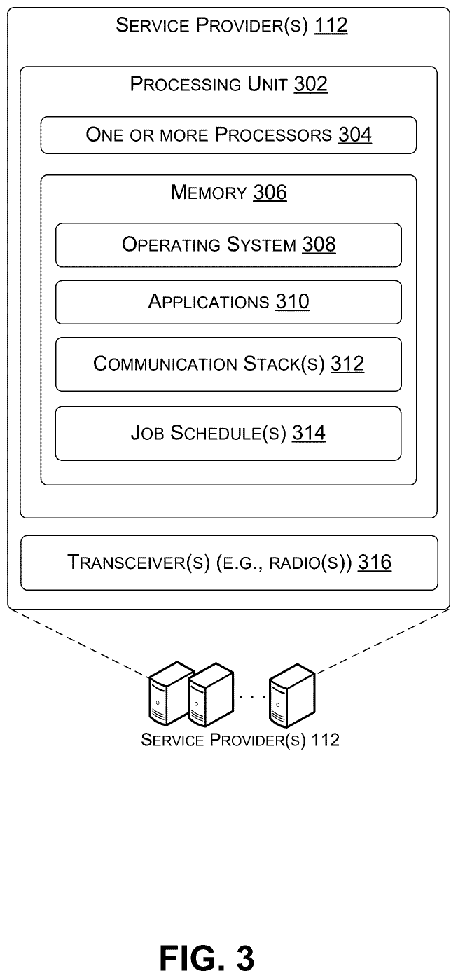

FIG. 3 is a diagram showing details of an example service provider(s) 112. The service provider(s) 112 of FIG. 3 is similar in some respects to device 200. To the extent that the service provider(s) 112 and device 200 include the same or similar components, the functions will not be repeated here. For instance, the service provider(s) 112 include various components to perform the operations discussed herein, such as a processing unit 302, one or more processors 304, a memory 306, an operating system 308, applications 310, communication stacks 312, and transceivers 316.

Service providers 112 may include job schedules 314 generated for devices, such as the devices 102 and/or the devices 104. The service providers 112 may obtain MO push schedules from remotely deployed device (e.g., smart utility meters) and generate job schedules 314 to track which devices are scheduled to be included in each job operation. A job schedule may include a period of time in which the service provider 112 (e.g., also referred to as the system) may receive communications (e.g., utility data) from devices and perform one or more operations, such as data processing. It may be desirable to obtain the MO push schedules from the devices in order to know which devices to expect to be receiving communications from and when to expect to receive the communications. For example, it may be desirable for device performance tracking to track which devices the service provider 112 has successfully received and processed data and the devices for which it has not. The service provider 112 may also utilize the job schedule 314 to allocate CPU and memory to process data received by the devices (e.g., endpoints). Job schedules 314 and tracking of job status may be used by the service provider 112 to manage CPU and/or memory utilization so that expected data from devices can be processed without the utility service running out of or exhausting computing resources. In some cases, a job may include receiving utility data from the endpoint device, processing the utility data to determine a utility usage of a user associated with the endpoint device, sending an update to the endpoint device, etc.

### Example Processes

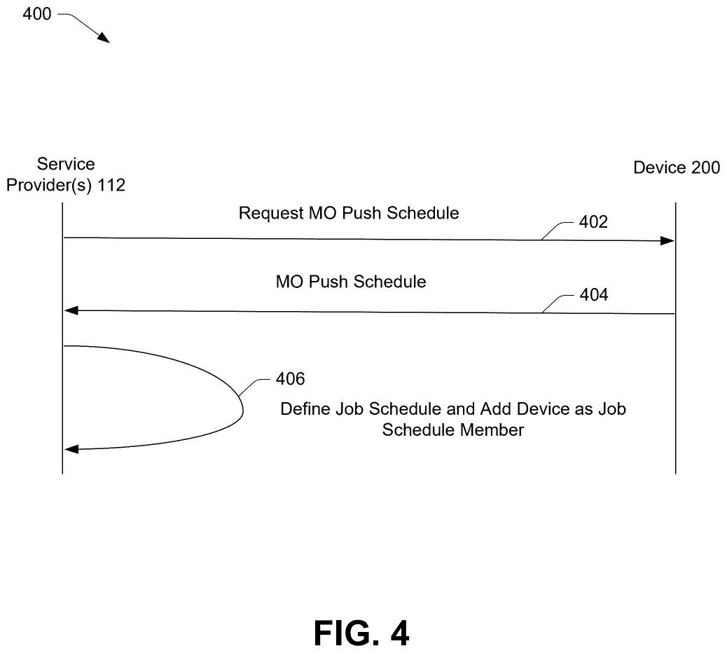

FIG. 4 illustrates an example process 400 for service providers 112 to receive identifying information for the device 200 (which may include devices 102 and/or the devices 104), such as a medium access control (MAC) address and may send a request 402 to the device 200 (also referred to as “endpoint devices”) for a MO push schedule. In some examples, the service providers 112 may receive a message 404 that may include the MO push schedule from the device 200 and determine if the MO push schedule corresponds to a job schedule. For example, the service providers 112 may store multiple job schedules associated with communicating with utility devices, such as device 200. A job schedule may include a period of time in which the service providers 112 may expect to receive communications (e.g., utility data) from device 200 and perform one or more operations, such as data processing. In some cases, the service providers 112 may perform an operation 406 to determine if the received MO push schedule corresponds to a previous job schedule and may add the device 200 to the job schedule for further communication. In other cases, operation 406 may include the service providers 112 determining that the MO push schedule does not correspond to an existing job schedule and may generate a new job schedule and add the device 200 to the new job schedule.

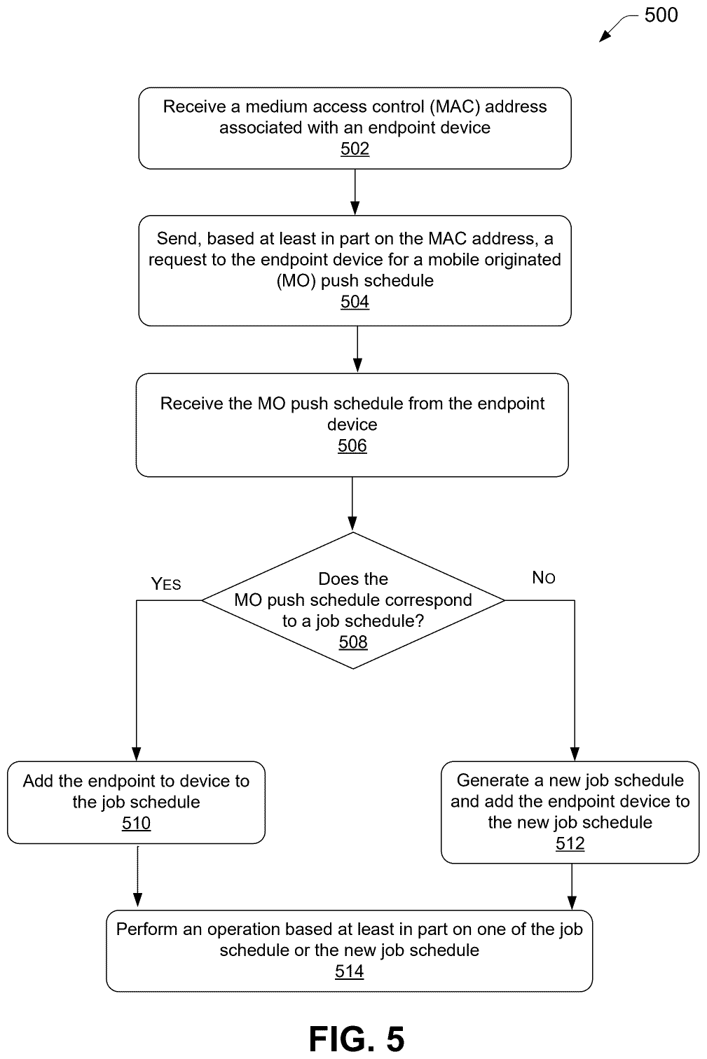

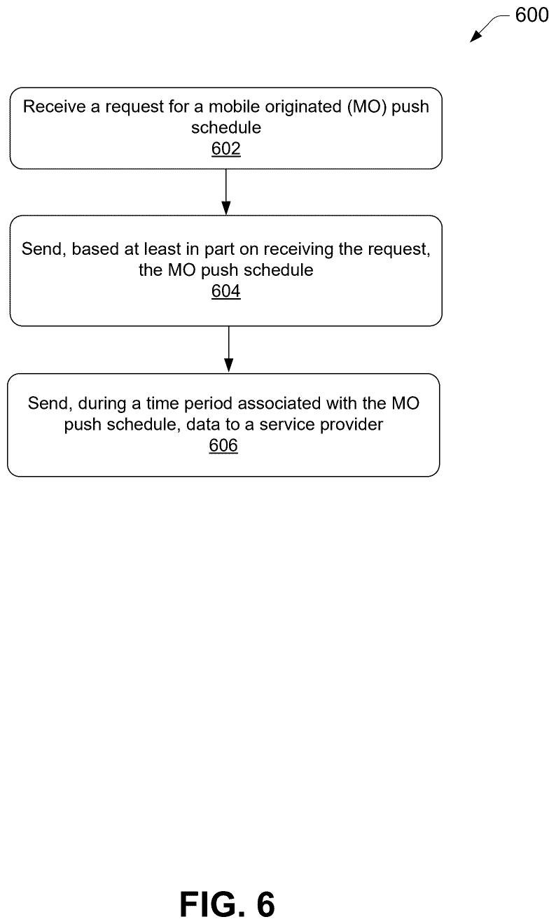

FIGS. 5 and 6 illustrate example processes 500 and 600 for employing the techniques discussed herein. For case of illustration the processes 500 and 600 may be described as being performed by a device described herein, such as the device 102, the device 104, the device 200, and/or the service provider 112. However, the processes 500 and 600 may be performed by other devices. Moreover, the devices may be used to perform other processes.

The processes 500 and 600 (as well as each process described herein) illustrate a logical flow graph, each operation of which represents a sequence of operations that can be implemented in hardware, software, or a combination thereof. In the context of software, the operations represent computer-readable instructions stored on one or more computer-readable storage media that, when executed by one or more processors, perform the recited operations. Generally, computer-readable instructions include routines, programs, objects, components, data structures, and the like that perform particular functions or implement particular abstract data types. In some contexts of hardware, the operations may be implemented (e.g., performed) in whole or in part by hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The order in which the operations are described is not intended to be construed as a limitation, and any number of the described operations can be combined in any order and/or in parallel to implement the process. Further, any number of the described operations may be omitted.

FIG. 5 illustrates the example process 500 to obtain a MO push schedule for a device.

At 502, the process 500 may include receiving a MAC address associated with an endpoint device. For example, the endpoint device may be implemented as mains powered devices (MPDs) that are connected to mains electricity (e.g., electricity meters), or implemented as battery powered devices (BPDs) that are not connected to mains electricity (e.g., water meters, gas meters, etc. that employ batteries). However, in other examples, the endpoint device may have different processing power, processing capabilities, and so on.

At 504, the process 500 may include sending, based at least in part on the MAC address, a request to the endpoint device for a mobile originated (MO) push schedule. For example, service providers 112 may receive identifying information for the device 200 (which may include devices 102 and/or the devices 104), such as a medium access control (MAC) address and may send a request to the device 200 (also referred to as “endpoint devices”) for a MO push schedule.

At 506, the process 500 may include receiving the MO push schedule from the endpoint device. For example, the endpoint device may also include an MO push schedule 222 configured to store communication time periods in which the device 200 is configured to generate and send communications. In some cases, the endpoint device may be configured to provide the MO push schedule 222 to other devices. For instance, device 200 may receive a request from a service provider, such as the service provider 112, to provide the service provider with the MO push schedule 222. In response, the endpoint device may send a communication to the service provider including the MO push schedule 222.

At 508, the process 500 may include determining if the MO push schedule corresponds to an existing job schedule. For example, the service providers 112 may store multiple job schedules associated with communicating with utility devices, such as devices 102 and/or the devices 104. A job schedule may include a period of time in which the service providers 112 may expect to receive communications (e.g., utility data) from devices 102 and/or the devices 104 and perform one or more operations, such as data processing.

At 510, the process 500 may include, in response to the MO push schedule corresponding to an existing job schedule, adding the endpoint device to the existing job schedule. For example, the service providers 112 may determine that the received MO push schedule corresponds to a previous job schedule and may add the devices 102 and/or the devices 104 to the job schedule for further communication.

At 512, the process 500 may include, in response to the MO push schedule not corresponding to the job schedule, generating a new job schedule and adding the endpoint device to the new job schedule. For example, the service providers may determine that the MO push schedule does not correspond to an existing job schedule and may generate a new job schedule and add the devices 102 and/or the devices 104 to the new job schedule.

At 514, the process 500 may include performing an operation based at least in part on one of the existing job schedule or the new job schedule. For example, the operations may include receiving utility data from the endpoint device, processing the utility data to determine a utility usage of a user associated with the endpoint device, sending an update to the endpoint device, etc. In some cases, the endpoint device may provide other types of data during an operation, such as diagnostic and/or performance data (e.g., network data, battery data, and/or device data used to track and manage the health of the device and network).

FIG. 6 illustrates the example process 600 to provide a MO push schedule for a device.

At 602, the process 600 may include receiving a request for a mobile originated (MO) push schedule. For example, an endpoint device may be implemented as mains powered devices (MPDs) that are connected to mains electricity (e.g., electricity meters), or implemented as battery powered devices (BPDs) that are not connected to mains electricity (e.g., water meters, gas meters, etc. that employ batteries). However, in other examples, the endpoint device may have different processing power, processing capabilities, and so on. Service providers 112 may receive identifying information for the device 200 (which may include devices 102 and/or the devices 104), such as a medium access control (MAC) address and may send a request to the device 200 (also referred to as “endpoint devices”) for a MO push schedule.

At 604, the process 600 may include sending, based at least in part on receiving the request, the MO push schedule. For example, the endpoint device may also include an MO push schedule 222 configured to store communication time periods in which the device 200 is configured to generate and send communications. In some cases, the endpoint device may be configured to provide the MO push schedule 222 to other devices. For instance, device 200 may receive a request from a service provider, such as the service provider 112, to provide the service provider with the MO push schedule 222. In response, the endpoint device may send a communication to the service provider including the MO push schedule 222.

At 606, the process 600 may include sending, during a time period associated with the MO push schedule, data to a service provider. For example, the service providers 112 may store multiple job schedules associated with communicating with utility devices, such as devices 102 and/or the devices 104. A job schedule may include a period of time in which the service providers 112 may expect to receive communications (e.g., utility data) from devices 102 and/or the devices 104 and perform one or more operations, such as data processing. For example, the operations may include receiving utility data from the endpoint device, processing the utility data to determine a utility usage of a user associated with the endpoint device, sending an update to the endpoint device, etc.

What is claimed is:

1. A method comprising:
receiving identifying information associated with an endpoint device;
sending, based at least in part on the identifying information, a request to the endpoint device for a mobile originated (MO) push schedule;
receiving the MO push schedule from the endpoint device;
determining if the MO push schedule corresponds to an existing job schedule; and
one of:
adding the endpoint device to the existing job schedule based on the MO push schedule corresponding to the existing job schedule; or
generating a new job schedule and adding the endpoint device to the new job schedule based on the MO push schedule differing to the existing job schedule.

2. The method of claim 1, wherein the endpoint device comprises a utility meter and the method further comprises, based at least in part on the existing job schedule:
receiving utility data from the endpoint device; and
processing the utility data to determine a utility usage of a user associated with the endpoint device.

3. The method of claim 1, wherein the existing job schedule comprises a period of time in which a remote computing system is configured to receive communications from a number of endpoints associated with the period of time.

4. The method of claim 1, further comprising:
determining at least one of a number of endpoint devices listed on the existing job schedule or at least one action associated with the existing job schedule;
determining a processing power associated with communicating with at least one endpoint device based at least in part on the number of endpoint devices or the at least one action; and
allocating the processing power to a system associated with communicating with the at least one endpoint device or performing the at least one action.

5. The method of claim 1, further comprising:
determining a time frame associated with at least one of the existing job schedule or the new job schedule; and
determining if a communication was received from the endpoint device during the time frame.

6. The method of claim 1, further comprising:
in response to the receiving a communication from the endpoint device, updating a service level agreement indicating that the communication was received; or
in response to not receiving a communication from the endpoint device, updating a service level agreement indicating that the communication was not received.

7. The method of claim 1, further comprising:
determining a current period of time;
determining a job schedule associated with the current period of time;
identifying one or more endpoints associated with the existing job schedule; and
sending, in response to the one or more endpoints being associated with the existing job schedule, an update to the one or more endpoints.

8. One or more non-transitory computer-readable storage media storing computer-readable instructions that, when executed, instruct a processing unit of a limited function device to perform operations comprising:
receiving identifying information associated with an endpoint device;
sending, based at least in part on identifying information, a request to the endpoint device for a mobile originated (MO) push schedule;
receiving the MO push schedule from the endpoint device;
determining if the MO push schedule corresponds to an existing job schedule; and
one of:
adding the endpoint device to the existing job schedule based on the MO push schedule corresponding to the existing job schedule; or
generating a new job schedule and adding the endpoint device to the new job schedule based on the MO push schedule differing to the existing job schedule.

9. The one or more computer-readable storage media of claim 8, wherein the endpoint device comprises a utility meter and the identifying information comprises a medium access control (MAC) address.

10. The one or more computer-readable storage media of claim 8, wherein the existing job schedule comprising a period of time in which a remote computing system is configured to receive communications from a number of endpoints associated with the period of time.

11. The one or more computer-readable storage media of claim 8, further comprising:
determining at least one of a number of endpoint devices listed on the existing job schedule or at least one action associated with the existing job schedule;
determining a processing power associated with communicating with at least one endpoint device based at least in part on the number of endpoint devices or the at least one action; and
allocating the processing power to a system associated with communicating with the at least one endpoint device or performing the at least one action.

12. The one or more computer-readable storage media of claim 8, further comprising:
determining a time frame associated with at least one of the existing job schedule or the new job schedule; and
determining if a communication was received from the endpoint device during the time frame.

13. The one or more computer-readable storage media of claim 8, further comprising:
in response to the receiving a communication from the endpoint device, updating a service level agreement indicating that the communication was received; or
in response to not receiving a communication from the endpoint device, updating a service level agreement indicating that the communication was not received.

14. The one or more computer-readable storage media of claim 8, wherein the existing job schedule is associated with performing one or more actions including processing utility data.

15. A system comprising:
a computing device comprising one or more processors and one or more non-transitory computer-readable media; and
an endpoint device communicatively coupled the computing device, the endpoint device configured to:
receive a request for a MO push schedule; and
send the MO push schedule to the computing device;
wherein the computing device comprises instructions that, when executed by the one or more processors, configure the computing device to:
send the request to the endpoint device for the MO push schedule;
receive the MO push schedule from the endpoint device; and
determine if the MO push schedule correspond to an existing job schedule.

16. The system of claim 15, wherein the endpoint device comprises a utility meter.

17. The system of claim 15, wherein the existing job schedule comprising a period of time in which a remote computing system is configured to receive communications from a number of endpoints associated with the period of time.

18. The system of claim 15, further comprising:
determining at least one of a number of endpoint devices listed on the existing job schedule or at least one action associated with the existing job schedule;
determining a processing power associated with communicating with at least one endpoint device based at least in part on the number of endpoint devices or the at least one action; and
allocating the processing power to a system associated with communicating with the at least one endpoint device or performing the at least one action.

19. The system of claim 15, further comprising:
determining a time frame associated with at least one of the existing job schedule or a new job schedule; and
determining if a communication was received from the endpoint device during the time frame.

20. The system of claim 15, further comprising:
generating, by the endpoint device, an updated MO push schedule;
sending, by the endpoint device, the updated MO push schedule to the computing device;
receiving, by the computing device, the updated MO push schedule; and
one of:
maintaining, by the computing device, the endpoint device on the existing job schedule based on the updated MO push schedule corresponding to the existing job schedule; or
generating the new job schedule and adding the endpoint device to the new job schedule based on the updated MO push schedule differing to the existing job schedule.
